(19) United States
(12) Patent Application Publication
(10) Pub. No.: US 2015/0104082 A1
(43) Pub. Date: Apr. 16, 2015

(54) IMAGE PROCESSING APPARATUS AND CONTROL METHOD THEREOF

(71) Applicant: SAMSUNG ELECTRONICS CO., LTD., Suwon-si (KR)

(72) Inventors: Sang-yoon KIM, Yongin-si (KR); Ki-jun JEONG, Seoul (KR); Eun-heui JO, Suwon-si (KR)

(73) Assignee: SAMSUNG ELECTRONICS CO., LTD., Suwon-si (KR)

(21) Appl. No.: 14/321,037

(22) Filed: Jul. 1, 2014

(30) Foreign Application Priority Data
Oct. 15, 2013 (KR) 10-2013-0122647

(51) Int. Cl. G06K 9/00; G06K 9/62

(52) U.S. Cl. CPC G06K 9/00268; G06K 9/6215
USPC 382/118

(57) ABSTRACT

An image processing apparatus includes: a processor configured to process an image photographed by the camera and determine a user face within the image; and a controller configured to control the processor to determine whether same user faces appear in a plurality of video frames by tracing one or more user faces within the respective video frames included in the image.

### CROSS-REFERENCE TO RELATED APPLICATION

This application claims priority from Korean Patent Application No. 10-2013-0122647, filed on Oct. 15, 2013 in the Korean Intellectual Property Office, the disclosure of which is incorporated herein by reference.

### BACKGROUND

1. Field

Apparatuses and methods consistent with the exemplary embodiments relate to an image processing apparatus which processes video data to be displayed as an image and a control method thereof, and more particularly to an image processing apparatus and a control method thereof, in which faces of users within an image photographed by a camera are recognized to identify the users within the image.

2. Description of the Related Art

An image processing apparatus processes a video signal/video data received from an external environment, through various imaging processes. The image processing apparatus displays the processed video signal as an image on its own display panel, or outputs the processed video signal to a separate display apparatus so that the processed video signal can be displayed as an image on the display apparatus having a display panel. That is, the image processing apparatus may include a display panel capable of displaying an image or may not include the display panel as long as it can process the video signal. As an example of the former case, there is a television (TV). Further, as an example of the latter case, there is a set-top box.

With development of technology, various functions of the image processing apparatus has continuously been added and extended. For example, the image processing apparatus may photograph one or more persons present in front thereof through a camera, and recognize and identify his/her faces within the image to thereby perform corresponding operations. For instance, logging-in to an account of the image processing apparatus may be achieved by recognizing a user's face instead of inputting identification (ID) and a password.

As a method of recognizing a human's face included in an image photographed by the camera, a modeling based analysis method employing a three-dimensional (3D) camera may be used. In this method, a human's face and head are modeled through the 3D camera, and then the face is recognized based on the modeling results. This method is expected to precisely recognize a human's face, but it may be not easy to practically apply this method to a general TV or the like since a data throughput is large and its realization has a high level of difficulty. Thus, a method and structure are needed for easily recognizing and identifying a human's face on an image photographed by a two-dimensional (2D) camera.

### SUMMARY

The foregoing and other aspects may be achieved by providing an image processing apparatus including: a processor configured to process an image photographed by a camera and determine a user face within the image; and a controller configured to control the processor to determine whether same user faces appear in a plurality of video frames by tracing one or more user faces within the respective video frames included in the image.

The image processing apparatus may further include a storage configured to store at least one profile of a preset face, wherein the controller may extract a feature vector of a user face from the video frame, determine similarity by comparing a first feature vector of the user face with a second feature vector of the at least one profile stored in the storage, and perform analysis of the user face based on a determined history of the similarities with regard to the respective video frame.

The controller may determines that the user face corresponds to the at least one profile if a number of user faces being determined as corresponding to the at least one profile is higher than a preset value.

The controller may update the at least one profile with the first feature vector if it is determined that the user face corresponds to the at least one profile.

The controller may determine that the user face does not correspond to the previously stored profile and is new if a number of user faces being determined as corresponding to the at least one profile is lower than a preset value.

The controller may store the first feature vector and may register a new profile with the first feature vector if it is determined that a user face is new.

The controller may determine that the user face corresponds to the at least one profile if similarity between the first feature vector and the second feature vector is higher than a preset level.

The controller may determine reliability about recognition of respective facial structures, and extract a feature vector of the user face if the reliability is equal to or higher than a preset level.

The controller, based on data of video frame regions respectively forming faces detected within one video frame, may trace the same user face in subsequent video frames.

The foregoing and other aspects may be achieved by providing a method of controlling an image processing apparatus, the method including: receiving an image; determining whether same user faces appear in a plurality of video frames by tracing one or more user faces within the respective video frames included in the image.

The determining whether the same user faces appear may include: extracting a feature vector of a user face from the video frame; determining similarity by comparing a first feature vector of the user face with a second feature vector of at least one profile of a preset face, and performing analysis of the user face based on a determined history of similarities with regard to the respective video frame.

The performing analysis of the user face may include: determining that the user face corresponds to the at least one profile if a number of user faces being determined as corresponding to the profile is higher than a preset value.

The performing the analysis of the user face may include: updating the at least one profile with the first feature vector if it is determined that the user face corresponds to the at least one profile.

The performing the analysis of the user face may include: determining that the user face does not correspond to the previously stored profile and is new if a number of user faces being determined as corresponding to the at least one profile, is lower than a preset value.

The performing the analysis of the user face may include: registering a new profile with the first feature vector if it is determined that user face is new.

The determining the similarity may include: determining that the user face corresponds to the at least one profile if similarity between the first feature vector and the second feature vector is higher than a preset level.

The extracting the feature vector of the user face may include: determining reliability of recognition of respective facial structures with regard to the user face detected in the video frame, and extracting the feature vector of the user face if the reliability is equal to or higher than a preset level.

The determining whether the same user faces appear in the respective video frames may include: tracing the same user face in subsequent video frames, based on data of video frame regions respectively forming faces detected within one video frame.

The image processing apparatus may further include a camera.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 shows an example of a display apparatus according to an exemplary embodiment;

FIG. 2 is a block diagram of a display apparatus of FIG. 1;

FIG. 3 is a block diagram of a processor in the display apparatus of FIG. 1;

FIG. 4 shows a table showing a history of recognizing a plurality of video frames for a predetermined period of time, processed in the display apparatus of FIG. 1; and

FIGS. 5 and 6 are flowcharts of identifying a face within an image by the display apparatus of FIG. 1.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, but this does not mean that the omitted parts are unnecessary for realization of apparatuses or systems to which the exemplary embodiments are applied Like reference numerals refer to like elements throughout.

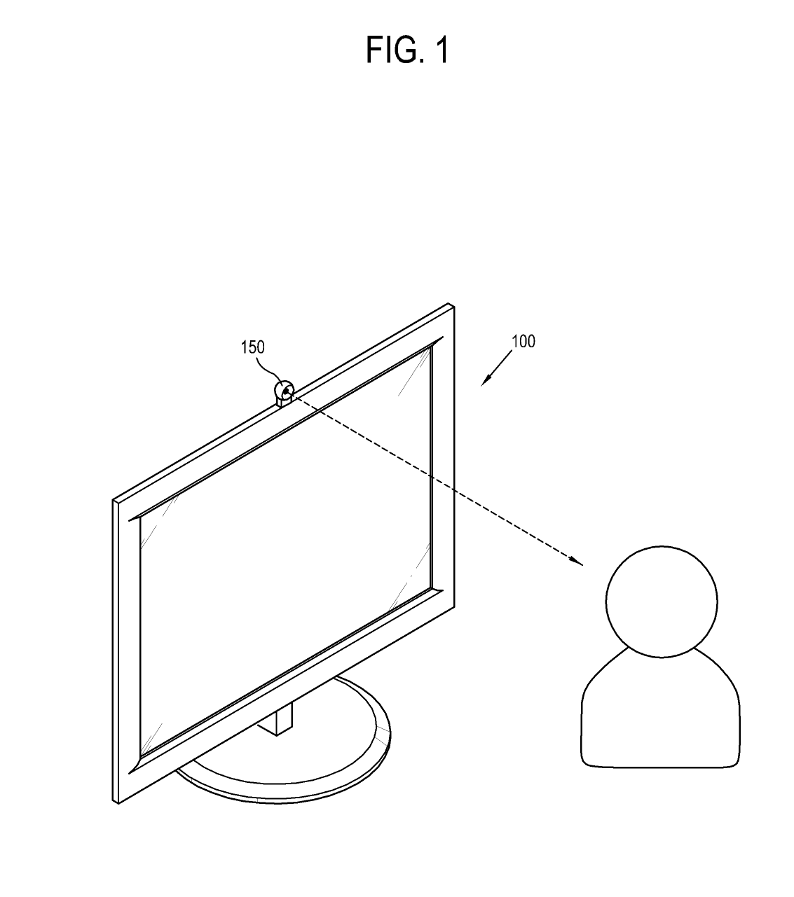

FIG. 1 shows an example of an image processing apparatus 100 according to an exemplary embodiment. In this exemplary embodiment, the image processing apparatus 100 is achieved by a display apparatus having a structure capable of displaying an image by itself. However, an exemplary embodiment may even be applied to an apparatus that cannot display an image by itself, like a set-top box, and in this case the image processing apparatus 100 is locally connected to a separate external display apparatus so that the image can be displayed on the external display apparatus.

As shown in FIG. 1, the display apparatus 100 according to this exemplary embodiment processes video data and displays an image based on the video data, thereby displaying the image to a frontward user. As a general example of the display apparatus 100, there is a television (TV). In this exemplary embodiment, the TV will be described as an example of the display apparatus 100.

In accordance with various events generated by a user, the display apparatus 100 carries out a preset operation or function corresponding to the event. As one of the events, it is determined whether a user's face, which is located in front of the display apparatus 100, corresponds to a previously stored human face profile. To this end, the display apparatus 100 includes a camera 150 for photographing external environments.

The display apparatus 100 analyzes an image photographed by the camera 150 in order to recognize a user's face on the photographed image, and determines whether the recognized face corresponds to a face profile previously stored in the display apparatus 100 or does not correspond to any profile. If a profile corresponding to a user's face is determined, the display apparatus 100 performs a preset function based on the determination result. For example, if it is setup to log in to an account in accordance with results of recognizing a user's face, the display apparatus 100 performs login to an account previously designated to a certain profile when it is analyzed that a user's face within an image photographed for a predetermined period of time corresponds to the profile.

Below, the configurations of the display apparatus 100 are as follows.

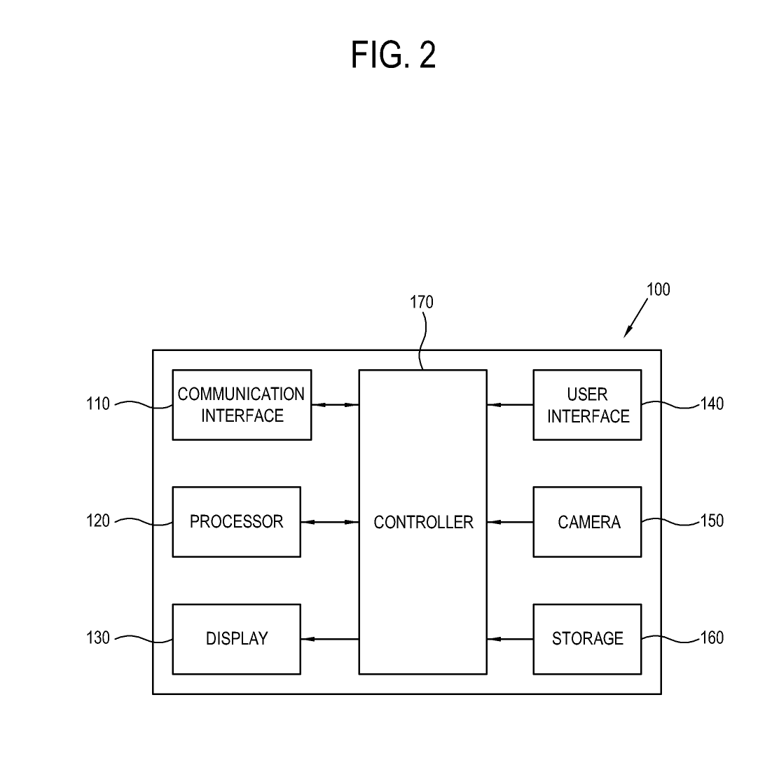

FIG. 2 is a block diagram of the display apparatus 100.

As shown in FIG. 2, the display apparatus 100 includes a communication interface 110 which performs communication with an exterior to transmit/receive data/a signal, a processor 120 which processes data received in the communication interface 110 in accordance with preset processes, a display 130 which displays video data as an image if data processed in the processor 120 is the video data, a user interface 140 which is for a user's input, a camera 150 which photographs external environments of the display apparatus 100, a storage 160 which stores data/information, and a controller 170 which controls general operations of the display apparatus 100.

The communication interface 110 transmits/receives data so that interactive communication can be performed between the display apparatus 100 and a server or an external device (not shown). The communication interface 110 accesses the server or the external device (not shown) through wide/local area networks or locally in accordance with preset communication protocols.

The communication interface 110 may be achieved by connection ports according to devices or an assembly of connection modules, in which the protocol for connection or the external device for connection is not limited to one kind or type. The communication interface 110 may be a built-in device of the display apparatus 100, or the entire or a part thereof may be added to the display apparatus 100 in the form of an add-on or dongle type of attachment.

The communication interface 110 transmits/receives a signal in accordance with protocols designated according to the connected devices, in which the signals can be transmitted/received based on individual connection protocols with regard to the connected devices. In the case of video data, the communication interface 110 may transmit/receive the signal bases on various standards such as a radio frequency (RF) signal, composite/component video, super video, Syndicat des Constructeurs des Appareils Radiorecepteurs et Téléviseurs (SCART), high definition multimedia interface (HDMI), display port, unified display interface (UDI), or wireless HD, etc.

The processor 120 performs various processes with regard to data/a signal received in the communication interface 110. If the communication interface 110 receives the video data, the processor 120 applies an imaging process to the video data and the video data processed by this process is output the display 130, thereby allowing the display 130 to display an image based on the corresponding video data. If the signal received in the communication interface 110 is a broadcasting signal, the processor 120 extracts video, audio and appended data from the broadcasting signal tuned to a certain channel, and adjusts an image to have a preset resolution, so that the image can be displayed on the display 130.

There is no limit to the kind of imaging processes to be performed by the processor 120. For example, the types of imaging processes include, but are not limited to, a decoding process which corresponds to an image format of the video data, a de-interlacing process for converting the video data from an interlace type into a progressive type, a scaling process for adjusting the video data to have a preset resolution, a noise reduction process for improving image qualities, a detail enhancement process, a frame refresh rate conversion process, etc.

The processor 120 may perform various processes in accordance with the kinds of data and attributes of data, and thus the process to be implemented in the processor 120 is not limited to the imaging process. Also, the data that is processable in the processor 120 is not limited to only that which is received in the communication interface 110. For example, the processor 120 processes a user's utterance through a preset voicing process when the user interface 140 receives the corresponding utterance.

The processor 120 may be achieved by an image processing board (not shown), where a system-on-chip where various functions are integrated or an individual chip-set capable of independently performing each process is mounted on a printed circuit board. The processor 120 may be built-in the display apparatus 100.

The display 130 displays the video signal/the video data processed by the processor 120 as an image. The display 130 may be achieved by various display types such as liquid crystal, plasma, a light-emitting diode, an organic light-diode, a surface-conduction electron-emitter, a carbon nano-tube and a nano-crystal, but is not limited thereto.

The display 130 may additionally include an appended element in accordance with its types. For example, in the case of the liquid crystal type, the display 130 may include a liquid crystal display (LCD) panel (not shown), a backlight unit (not shown) which emits light to the LCD panel, a panel driving substrate (not shown) which drives the panel (not shown), etc.

The user interface 140 transmits various preset control commands or information to the controller 170 in accordance with a user's control or input. The user interface 140 operates to receive information/input related to various events that occur in accordance with a user's intentions and transmits the information/input to the controller 170. Here, the events that occur by a user may have various forms, and may for example include a user's control of a remote controller, utterance, etc.

The camera 150 photographs external environments of the display apparatus 100, in particular, a user's figure, and transmits a photographed result to the processor 120 or the controller 170. The camera 150 in this exemplary embodiment offers the photographed image of photographing a user's figure by a two-dimensional (2D) photographing method to the processor 120 or the controller 170, so that the controller 170 can specify a user's shape or figure within a video frame of the photographed image.

The storage 160 stores various data under control of the controller 170. The storage 160 is achieved by a nonvolatile memory such as a flash memory, a hard disk drive, etc. so as to retain data regardless of power on/off of the system. The storage 150 is accessed by the controller 170 so that previously stored data can be read, recorded, modified, deleted, updated, and so on.

In this exemplary embodiment, the storage 160 stores face profiles of one or more persons. These profiles are previously stored in the storage 160 and used as data for specifying persons, respectively. There is no limit to contents and formats of the profile data. In this exemplary embodiment, the profile may include one or more feature vectors used as criteria for comparing similarity to identify a face of one person, details of which will be described later.

The controller 160 is achieved by a central processing unit (CPU), and controls operations of general elements of the display apparatus 100, such as the processor 120, in response to occurrence of a predetermined event. In this exemplary embodiment, the controller 170 operates to recognize a user's face within an image photographed by the camera 150.

Specifically, the controller 170 controls the processor 120 to extract data specifying a user's face from an image photographed by the camera 150 for a predetermined period of time, and determine whether the data of the specified face corresponds to at least one among the previously stored profiles of one or more persons' faces. Here, the features of the data specifying a user's face may be a feature vector value formed with binary data/codes generated through a preset algorithm. This algorithm may be made based on various well-known techniques.

If it is determined that the data of the specified face within the photographed image corresponds to one profile, the controller 170 determines that a user's face corresponds to that profile. Further, the controller 170 updates the corresponding profile with the corresponding face.

On the other hand, if it is determined that the data of the specified face within the photographed image does not correspond to any profile, the controller 170 generates a new profile based on the corresponding data.

In accordance with determination results, a database of the previously stored profile is updated or added with the data of the face extracted from the photographed image, thereby improving accuracy of recognizing a user's face in the subsequent face recognizing process.

The operation where the display apparatus 100 recognizes a user's face may be carried out through the following processes by way of example. The display apparatus 100 may inform a user that his/her face will be photographed by the camera 150, through a user interface (UI) or voice, so that the user can be guided to consciously face toward the camera 150 and minimize any expression and motion. In response to the guides of the display apparatus 100, a user may stop a behavior in order to minimize variation in his/her expression, motion, pose, and like factors, which may adversely influence recognition of the user's face. Under the condition that a user stops the behavior as above, the display apparatus 100 photographs a user's face through the camera 150 and analyzes it.

However, this process is expected to accurately identify a user's face, but it may be inconvenient for a user since the user is guided to consciously adopt a stiff posture. Accordingly, there is needed a method of recognizing a face in real time according to various changes in a user's expression, motion, pose, etc., which may be made while the user has no idea that he/she is being photographed.

Thus, the following method is proposed according to an exemplary embodiment.

The display apparatus 100 traces one or more user's faces within the plurality of video frames included in the image photographed by the camera 150 for a predetermined period of time, and determines whether the faces of the same user's face appear on the respective video frames. Further, if it is determined that these video frames show the faces of one user, the display apparatus 100 starts identifying the faces of the corresponding user.

Thus, the display apparatus 100 may photograph a user in real time and recognize his/her face while s/he has no sense of being photographed.

Below, an exemplary embodiment will be described in more detail.

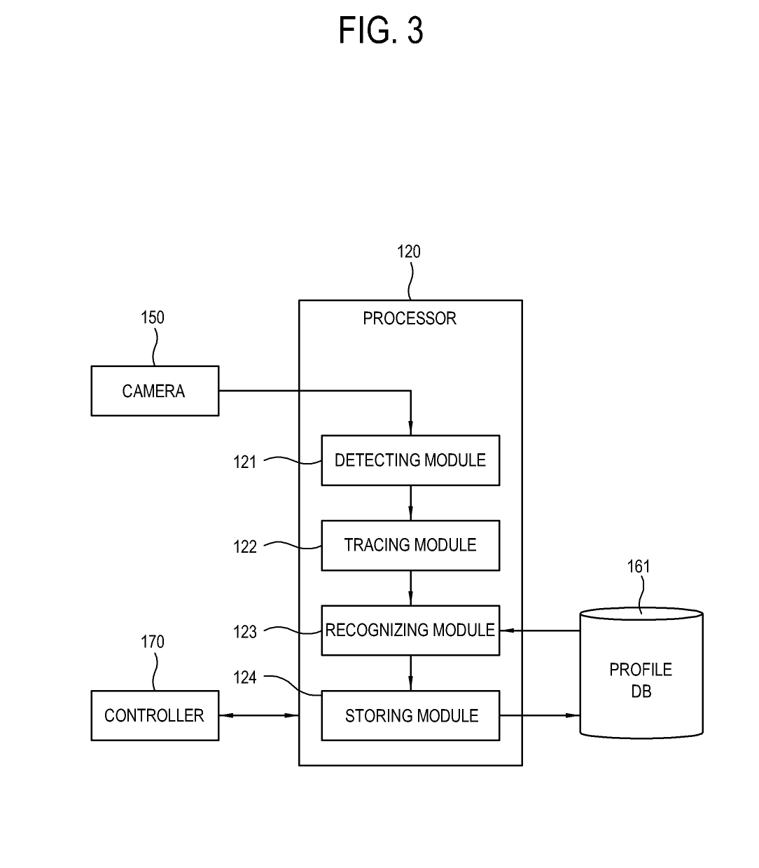

FIG. 3 is a block diagram of the processor 120.

As shown in FIG. 3, the processor 120 according to this exemplary embodiment include a plurality of blocks or modules 121, 122, 123 and 124 for processing the photographed image received from the camera 150.

These modules 121, 122, 123 and 124 are sorted with respect to functions for convenience, and do not limit the realization of the processor 120. These modules 121, 122, 123 and 124 may be achieved by hardware or software. The respective modules 121, 122, 123 and 124 that constitute the processor 120 may perform their operations independently. Alternatively, the processor 120 may not be divided into individual modules 121, 122, 123 and 124, and may perform all of the operations in sequence. Also, the operations of the processor 120 may be performed under control of the controller 170.

The processor 120 may include a detecting module 121, a tracing module 122, a recognizing module 123, and a storing module 124. Here, the recognizing module 123 and the storing module 124 can access a profile DB 161.

The detecting module 121 analyzes an image received from the camera 150, and detects a user's face within a video frame of the image. The detecting module 121 may employ various algorithms for detecting a user's face within the video frame. For example, the detecting module 121 derives a contour line detectable within the video frame, and determines whether the derived contour line corresponds to a series of structures forming a human's face, such as an eye, a nose, a mouth, an ear, a facial form, etc. Here, the detecting module 121 may detect one or more faces within one video frame.

The tracing module 122 assigns an ID to a face detected by the detecting module 121 within the video frame, and traces the same face corresponding to the ID with regard to the plurality of video frames sequentially processed for a preset period of time. The tracing module 122 traces the face assigned with a predetermined ID at the first video frame on the following video frames, and assigns the same ID to the traced faces. That is, that the faces within the plurality of video frames have the same ID means that the corresponding faces are the faces of one user.

The tracing module 122 traces the faces of one user on the following video frames, based on data of a video frame region forming a user's face having an ID assigned at the first face trace. Various well known methods may be used in a method of tracing the face. For example, a binary code is derived by a preset function or algorithm according to facial regions of the respective video frames, and it is determined whether the respective binary codes are related to the faces of one user by comparing a distribution situation, a change pattern and the like parameters of the binary values according to the respective codes.

As an example of a tracing algorithm for a predetermined object, there are a method of using motion information, a method of using shape information, a method of using color information, etc. The method of using the motion information has an advantage of detecting the object regardless of color or shape, but is difficult to detect an exact moving region of the object because a motion vector is ambiguous in an image. Meanwhile, a color information histogram-based tracing method is used in various tracing systems, which generally employs a MeanShift or CAMShift algorithm. This method obtains a histogram by converting a detected region of a face targeted for the tracing into a certain color space, inversely projects the histogram to the subsequent video frame based on this distribution, and repetitively finds the distribution of this tracing region.

The recognizing module 123 extracts a feature vector of a corresponding face in order to recognize a face of a video frame traced by the tracing module 122. The feature vector is feature data derived by an image analysis algorithm with regard to each facial structure such as an eye, a nose, a mouth, a contour, etc. in the region corresponding to the face within the video frame. The feature vector is a value derived based on positions, proportions, edge directions, contract differences, etc. of the respective facial structures. The feature vector may be obtained by various well known methods of extracting the feature vector, such as a principal component analysis (PCA), elastic bunch graph matching, linear discrimination analysis (LDA), etc., and thus detailed descriptions thereof will be omitted.

The recognizing module 123 determines similarity by comparing the feature vector extracted from the video frame with the feature vector according to the facial profiles stored in the profile DB 161. If similarity between a first feature vector extracted from the video frame and a second feature vector of the profile DB 161 is equal to or higher than a preset level, the recognizing module 123 determines that the face of the first feature vector corresponds to the facial profile of the second feature vector; that is, the first feature vector and the second feature vector are related to the faces of one user.

On the other hand, the recognizing module 123 determines that the face of the first feature vector is a new face not stored in the profile DB 161 if the first feature vector extracted from the video frame does not show high similarity with the feature vectors of any profiles stored in the profile DB 161.

Here, the similarity may be determined by various methods. For example, the first feature vector and the second feature vector are compared with respect to the binary code, and it is determined that the similarity is high if the number of binary values equal at the same code position is equal to or higher than a preset value or if a change pattern of the same binary value is included in common even though the code positions are different from each other. To make it easy to compare the first feature vector and the second feature vector, the recognizing module 123 normalizes the video frame to have a preset size or resolution and then extracts the feature vector.

The recognizing module 123 identifies the profile of the corresponding face, based on a plurality of determination results of the similarity obtained according to the respective video frames with respect to one face traced within the plurality of video frames. That is, the recognizing module 123 traces the faces of one user within the plurality of video frames for a predetermined period of time, and identifies the profile of the corresponding face if the tracing results show the faces of one user.

The storing module 124 allows the profile DB 161 to be updated or added with the final determination results of the recognizing module 123. If it is determined that the face on the image corresponds to one profile of the profile DB 161, the storing module 124 updates the corresponding profile of the profile DB 161 with the feature vector of the corresponding face. On the other hand, if it is determined that the profile DB 161 has no profile corresponding to the face on the image, the storing module 124 assigns a new registration ID to the feature vector data of the corresponding face and adds it to the profile DB 161.

While the recognizing module 123 recognizes the face traced by the tracing module 122 in the video frame, the recognizing module 123 determines reliability about recognition of respective facial structures in the facial region detected by the detecting module 121 and extracts the feature vector for the face recognition only when the reliability is equal to or higher than a preset level.

Here, the reliability is a parameter that is used as a criterion for allowing the recognizing module 123 to determine whether the feature vector extracted from the video frame is data to be compared with the feature vector of the profile DB 161. Various methods may be used with regard to how to determine the reliability. For example, the reliability is relatively high when all structures forming a user's face appear in the video frame.

On the other hand, if some of the structures forming the face do not appear, for example when one of two eyes on a face does not appear in the video frame, it is determined that the reliability is relatively low. In this case, the feature vector extracted from the video frame is not within a comparable deviation to be compared with the feature vector of the profile DB 161, and thus there is no effective manner of comparing them.

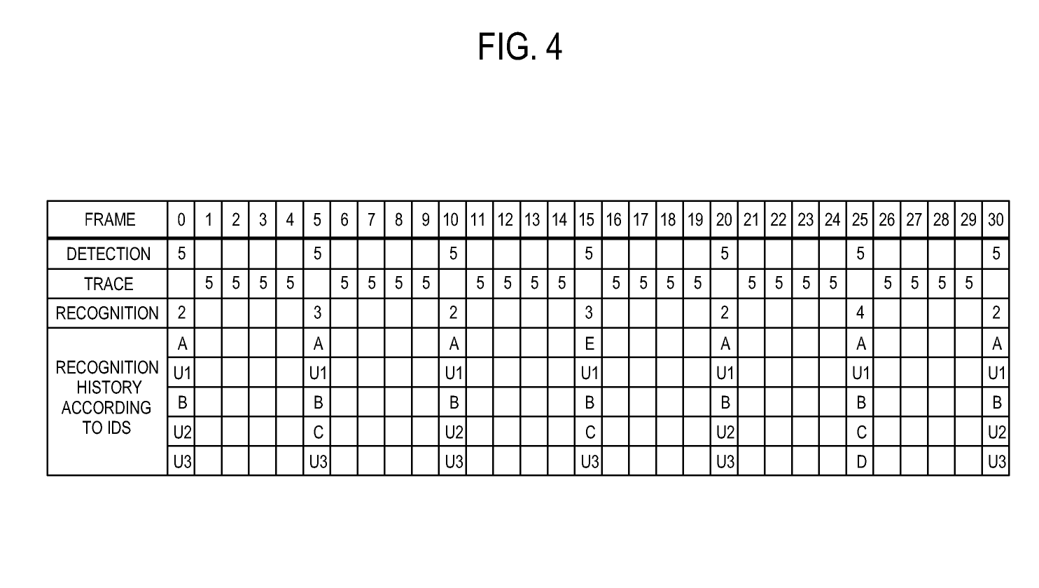

Below, a method of allowing the display apparatus 100 to recognize a user's face within an image photographed for a preset time section will be described with reference to FIG. 4.

FIG. 4 shows a table showing a history of recognizing a plurality of video frames for a predetermined period of time.

As shown in FIG. 4, in this exemplary embodiment, a process is performed to recognize a face from a plurality of video frames within an image photographed for a predetermined period of time. The total number of video frames to be analyzed is 31: numbers 0 to 30. In the table, “frame” on the first row shows a serial number of each video frame, in which frame No. 0 refers to a temporally first video frame and frame No. 30 refers to the last video frame.

In the table, “detection” on the second row shows the number of human faces detected by the detecting module 121 (refer to FIG. 3) within the corresponding video frame. In the table, “trace” on the third row shows the number of human faces traced by the tracing module 122 (refer to FIG. 3). In this exemplary embodiment, the detection is performed every five video frames, i.e., at frame No. 0, frame No. 5, frame No. 10, frame No. 15, frame No. 20, frame No. 25 and frame No. 30, and the face(s) detected in the preceding detection is traced at the other video frames.

In this exemplary embodiment, it will be understood that five faces of persons are detected within the video frame at every detection cycle, and five detected faces are successfully traced.

If four faces are traced and one face is not traced among the five faces, the recognition is applied only to the traced faces and not applied to the face not traced.

In the table, “recognition” on the fourth row indicates the number of faces within the video frame, which corresponds to the previously stored profiles. As described above, the recognition refers to an operation where the recognizing module 123 (refer to FIG. 3) performs a process with reference to the profile DB 161 (refer to FIG. 3). In this exemplary embodiment, the recognition is performed with regard to the video frame to which the detection is applied, but not limited thereto. Alternatively, the recognition may be performed with regard to the video frame to which the trace is applied. Also, the recognition in this exemplary embodiment is performed on the same cycle as the detection, but may be performed on a different cycle from the detection.

For instance, if five faces are detected during the detection and two faces are recognized during the recognition with respect to frame No. 0, it means that two faces among five faces detected at frame No. 0 correspond to the previously stored profiles and three faces do not correspond to the previously stored profiles.

In accordance with the recognition results, a tracing ID is assigned to each detected face.

In the table, “recognition history according to IDs” on the fifth row” refers to a history of tracing IDS assigned to the respective faces of the video frames in accordance with the recognition results. The tracing ID may be freely given as long as it can distinguish face units. In this exemplary embodiment, alphabets of A, B, C and so on are assigned to the face units.

Here, five rows in the item “recognition history according to IDs” respectively refer to faces each assigned with one distinguishing ID and traced as one face by the tracing module 122 (refer to FIG. 3). Here, the tracing IDs may be different during the determination for the feature vector even though the faces in the plurality of video frames have one distinguishing ID.

In the following exemplary embodiment, the tracing ID will be simply called an ID.

For instance, among the five detected faces at frame No. 0, the first and third faces are recognizable but the other faces are not recognizable. The display apparatus 100 assigns IDs of A and B to the recognizable video frame, and assigns IDS of U1, U2 and U3 to the unrecognizable video frames.

At frame No. 5, the first, third and fourth faces are recognizable. Here, the first and third faces have already been assigned with the IDs at frame No. 0, and therefore the same IDs are assigned in this case. The tracing ID refers to an ID assigned in such a manner. The display apparatus 100 assigns the ID of A, B and C to these faces. Also, the tracing IDs are assigned to the unrecognized second and fifth faces in connection with the previous frame No. 0, and therefore the display apparatus 100 assigns the IDs of U1 and U3 to these faces.

Regarding frame No. 10, the display apparatus 100 assigns IDs to respective faces on the same principle as the foregoing process.

Regarding frame No. 15, the first, third and fourth faces are recognizable. Here, the first face is recognizable, but shows a different recognition result from that of the preceding video frame. This case occurs when the feature vector of the first face in the current video frame corresponds to a profile different from that of the preceding video frame among the plurality of previously stored profiles. That is, the first face of frame No. 0 and the first face of frame No. 15 may be assigned with the same distinguishing ID because they are the faces of one user, but may be different in their respective tracing IDs based on the determination results of the feature vector.

Thus, the display apparatus 100 assigns a new ID of E to the first face.

Regarding frame Nos. 20, 25 and 30, the display apparatus 100 assigns the ID to each face on the same principle as the foregoing process.

If the history is accumulated as above, the display apparatus 100 applies the determination process to each face based on the accumulated history of IDs. For example, if four or more histories result in the same profile among seven ID histories of a certain face, the display apparatus 100 determines that the face corresponds to the same profile during the determination process.

In the case of the first face, the ID of A is assigned six times, and the ID of E is assigned once. Therefore, it is determined that this face corresponds to the profile related to A. The display apparatus 100 identifies the first face as the profile of A when the ID of A is assigned.

In the case of the second face, the ID of U1 is assigned seven times. The ID of U1 is assigned when the recognition is impossible, and therefore the display apparatus 100 identifies the second face as a new face that does not correspond to any previously stored profile.

In the case of the third face, the ID of B is assigned seven times. Therefore, it is determined that the third face corresponds to the profile related to B.

In the case of the fourth face, the ID of C is assigned three times, and the unrecognizable ID of U2 is assigned four times. Thus, the display apparatus 100 identifies the fourth face as a new face that does not correspond to any previously stored profile.

In the case of the fifth face, the ID of D is assigned once, and the unrecognizable ID of U3 is assigned six times. Thus, the display apparatus 100 identifies the fifth face as a new face that does not correspond to any previously stored profile.

With this method, the display apparatus 100 can easily identify a face detected within a photographed image.

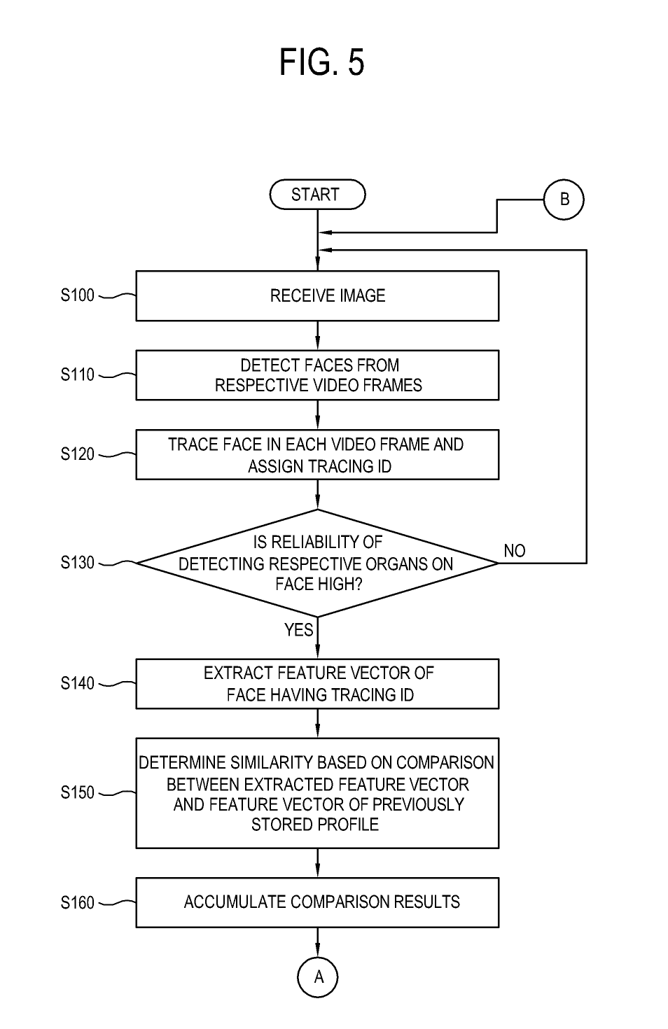

Below, a process of identifying a face within an image according to an exemplary embodiment will be described with reference to FIG. 5.

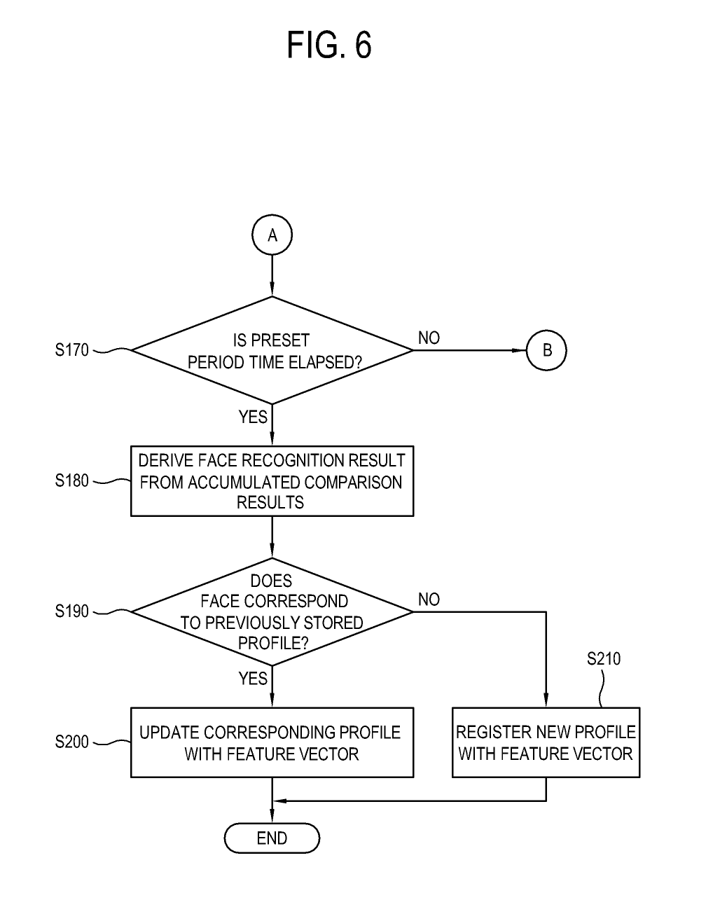

FIGS. 5 and 6 are flowcharts of identifying a face within an image by the display apparatus 100.

As shown in FIG. 5, at operation S100, the display apparatus 100 receives an image photographed in real time by the camera 15. At operation S110, the display apparatus 100 detects faces from video frames within the image. At operation S120, the display apparatus 100 traces faces in each video frame and assigns tracing IDs to the respective faces.

At operation S130, the display apparatus 100 determines whether reliability of detecting respective structures on the face is high. If it is determined that the reliability is low, the display apparatus 100 returns to the operation S100.

If it is determined that the reliability is high, at operation S140, the display apparatus 100 extracts the feature vector from the faces having the respective tracing IDs. At operation S150, the display apparatus 100 determines the similarity by comparing the extracted feature vector with the feature vector of the previously stored profile. At operation S160, the display apparatus 100 accumulates the comparison results.

As shown in FIG. 6, at operation S170 the display apparatus 100 currently determines whether a preset period of time is elapsed. If it is currently determined that a preset period of time is not elapsed, the display apparatus 100 returns to the operation S100.

If it is currently determined that a preset period of time is elapsed, at operation S180 the display apparatus 100 derives a face recognition result from the accumulated comparison results.

At operation S190, the display apparatus 100 determines whether the face corresponds to the previously stored profile, based on the face recognition results.

If the face corresponds to the previously stored profile, at operation S200 the display apparatus 100 updates the corresponding profile with the feature vector extracted in the preceding operation S140.

On the other hand, if the face does not correspond to the previously stored profile, at operation S210 the display apparatus 100 registers a new profile with the feature vector of the corresponding face.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An image processing apparatus comprising:
a processor configured to process an image photographed by a camera and determine a user face within the image; and
a controller configured to control the processor to determine whether same user faces appear in a plurality of video frames by tracing one or more user faces within the respective video frames included in the image.

2. The image processing apparatus according to claim 1, further comprising a storage configured to store at least one profile of a preset face,
wherein the controller extracts a feature vector of a user face from the video frame, determines similarity by comparing a first feature vector of the user face with a second feature vector of the at least one profile stored in the storage, and
performs analysis of the user face based on a determined history of similarities with regard to the respective video frame.

3. The image processing apparatus according to claim 2, wherein the controller determines that the user face corresponds to the at least one profile if a number of user faces being determined as corresponding to the at least one profile is higher than a preset value.

4. The image processing apparatus according to claim 3, wherein the controller updates the at least one profile with the first feature vector if it is determined that the user face corresponds to the at least one profile.

5. The image processing apparatus according to claim 2, wherein the controller determines that the user face does not correspond to a previously stored profile and is new if a number of user faces being determined as corresponding to the at least one profile is lower than a preset value.

6. The image processing apparatus according to claim 5, wherein the controller stores the first feature vector and registers a new profile with the first feature vector if it is determined that a user face is new.

7. The image processing apparatus according to claim 2, wherein the controller determines that the user face corresponds to the at least one profile if similarity between the first feature vector and the second feature vector is higher than a preset level.

8. The image processing apparatus according to claim 2, wherein the controller determines reliability about recognition of respective facial structures, and extracts the feature vector of the user face if the reliability is equal to or higher than a preset level.

9. The image processing apparatus according to claim 1, wherein the controller, based on data of video frame regions respectively forming faces detected within one video frame, traces the same user face in subsequent video frames.

10. A method of controlling an image processing apparatus, the method comprising:
receiving an image; and
determining whether same user faces appear in a plurality of video frames by tracing one or more user faces within the respective video frames included in the image.

11. The method according to claim 10, wherein the determining whether the same user faces appear comprises:
extracting a feature vector of a user face from the video frame;
determining similarity by comparing a first feature vector of the user face with a second feature vector of at least one profile of a preset face, and
performing analysis of the user face based on a determined history of similarities with regard to the respective video frame.

12. The method according to claim 11, wherein the performing analysis of the user face comprises:
determining that the user face corresponds to the at least one profile if a number of user faces being determined as corresponding to the profile is higher than a preset value.

13. The method according to claim 12, wherein the performing the analysis of the user face comprises:
updating the at least one profile with the first feature vector if it is determined that the user face corresponds to the at least one profile.

14. The method according to claim 11, wherein the performing the analysis comprises:
determining that the user face does not correspond to the previously stored profile and is new if a number of user faces being determined as corresponding to the at least one profile, is lower than a preset value.

15. The method according to claim 14, wherein the performing the analysis of the user face comprises:
registering a new profile with the first feature vector if it is determined that user face is new.

16. The method according to claim 11, wherein the determining the similarity comprises:
determining that the user face corresponds to the at least one profile if similarity between the first feature vector and the second feature vector is higher than a preset level.

17. The method according to claim 11, wherein the extracting the feature vector of the user face comprises:
determining reliability of recognition of respective facial structures with regard to the user face detected in the video frame, and extracting the feature vector of the user face if the reliability is equal to or higher than a preset level.

18. The method according to claim 10, wherein the determining whether the same user faces appear in the respective video frames comprises:
tracing the same user face in subsequent video frames, based on data of video frame regions respectively forming faces detected within one video frame.

19. The image processing apparatus according to claim 1, further comprising the camera.

20. The method according to claim 10, wherein the image is photographed by a camera of the image processing apparatus.
